(19) United States
(12) Patent Application Publication
(10) Pub. No.: US 2010/0125973 A1
(43) Pub. Date: May 27, 2010

(54) HINGE ASSEMBLY AND ELECTRONIC DEVICE USING THE SAME

(75) Inventors: JIN-XIN WANG, Shenzhen City (CN); XIAO-BO LI, Shenzhen City (CN); SHEN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/469,837

(22) Filed: May 21, 2009

(30) Foreign Application Priority Data
Nov. 25, 2008 (CN) 200810305722.2

(51) Int. Cl. E05F 1/08; E05D 5/10; E05D 11/10

(52) U.S. Cl. 16/303; 16/386; 16/319

(57) ABSTRACT

A hinge assembly includes a pivot shaft, a rotatable stand, a fixed stand, a cam, a cam follower, and a fastening member. The rotatable stand is non-rotatably connected to the pivot shaft and has a first fixing plate. The fixed stand is rotatably connected to the pivot shaft, and has a second fixing plate. The fastening member engages with an end of the pivot shaft. The cam follower defines two positioning cutouts. Two positioning protrusions are formed on the cam. One of the cam and the cam follower is rotatably connected to the pivot shaft. When the positioning protrusions engage in the positioning cutouts, the first fixing plate is oblique to the second fixing plate.

### CROSS-REFERENCE TO RELATED APPLICATIONS

This application is related to four co-pending U.S. patent applications, application Ser. No. 12/261,225 filed on Oct. 30, 2008, entitled “HINGE ASSEMBLY”, application Ser. No. 12/261,230 filed on Oct. 30, 2008, entitled “HINGE ASSEMBLY”, application Ser. No. 12/396,557 filed on Mar. 3, 2009, entitled “HINGE ASSEMBLY”, application Ser. No. 12/417,817 filed on Apr. 3, 2008, entitled “HINGE ASSEMBLY”. The co-pending applications have the same assignee as the present application.

### BACKGROUND

1. Technical Field

The present disclosure relates generally to hinge assemblies and electronic devices using the same and, more particularly, to a hinge assembly for a foldable electronic device.

2. Description of Related Art

A typical foldable electronic device such as a notebook computer generally has a main body and a cover with a display pivotally mounted on the main body via a typical hinge. The cover is latched to the main body via a hook positioned on the main body. However, the appearance of the notebook computer is unappealing because of the hook. Therefore the typical hinge generally has a fastening assembly to replace the hook positioned on the main body.

The typical hinge includes a pivot shaft, a first stand, a second stand, a fastening assembly, and a plurality of spring washers. The pivot shaft includes a shaft portion and a connecting portion formed on an end of the shaft portion. The first stand, the fastening assembly, and the spring washers are sleeved on the shaft portion. The second stand is non-rotatably sleeved on the connecting portion. The fastening assembly includes a cam and a cam follower. The cam is rotatably connected to the shaft portion, and the cam follower is non-rotatably connected to the shaft portion. A plurality of peaks is formed on a side surface of the cam. The cam follower defines a plurality of valleys receiving the peaks. The first stand has a first fixing plate, and the first fixing plate is fixed to the main body. The second stand has a second fixing plate, and the second fixing plate is fixed to the cover. When the cover is rotated towards the main body, the peaks of the cam engage with the valleys of the cam follower, and the first fixing plate is substantially parallel to the second fixing plate. Since the first fixing plate is fixed to the cover, and the second fixing plate is fixed to the main body, the cover is also substantially parallel to main body. Thus, a gap may be formed between the cover and the main body, and a height of the gap is substantially the same along a direction away from the hinge assembly. The cover may wobble relative to the main body due to this gap. That is, the cover cannot be firmly folded over the main body.

Therefore, a hinge assembly and an electronic device using the same to solve the aforementioned problems are desired.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded, isometric view of an embodiment of an electronic device, the electronic device including a main body, a cover, and an embodiment of a hinge assembly.

FIG. 2 is an exploded, isometric view of the hinge assembly in FIG. 1, the hinge assembly including a cam and a cam follower.

FIG. 3 is an isometric view of the cam and the cam follower of the hinge assembly in FIG. 2.

FIG. 3 is an assembled, isometric view of the hinge assembly in FIG. 1, but viewed from another aspect.

FIG. 4 is a side view of the electronic device of FIG. 1, with the cover closed over the main body.

### DETAILED DESCRIPTION

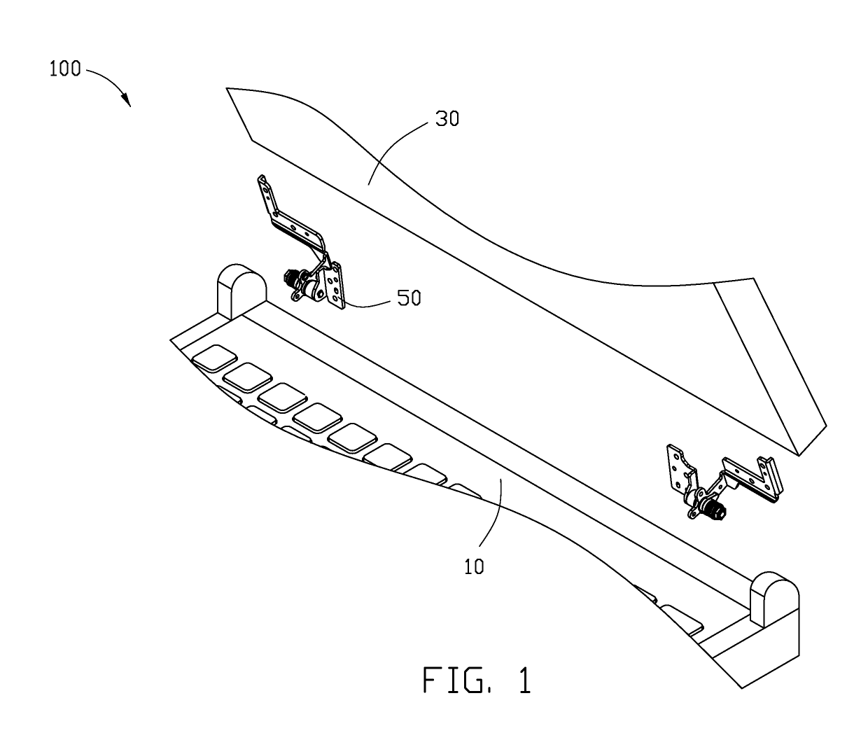

Referring to FIG. 1, an embodiment of an electronic device 100 includes a main body 10, a cover 30, and two hinge assemblies 50 connecting the cover 30 with the main body 10.

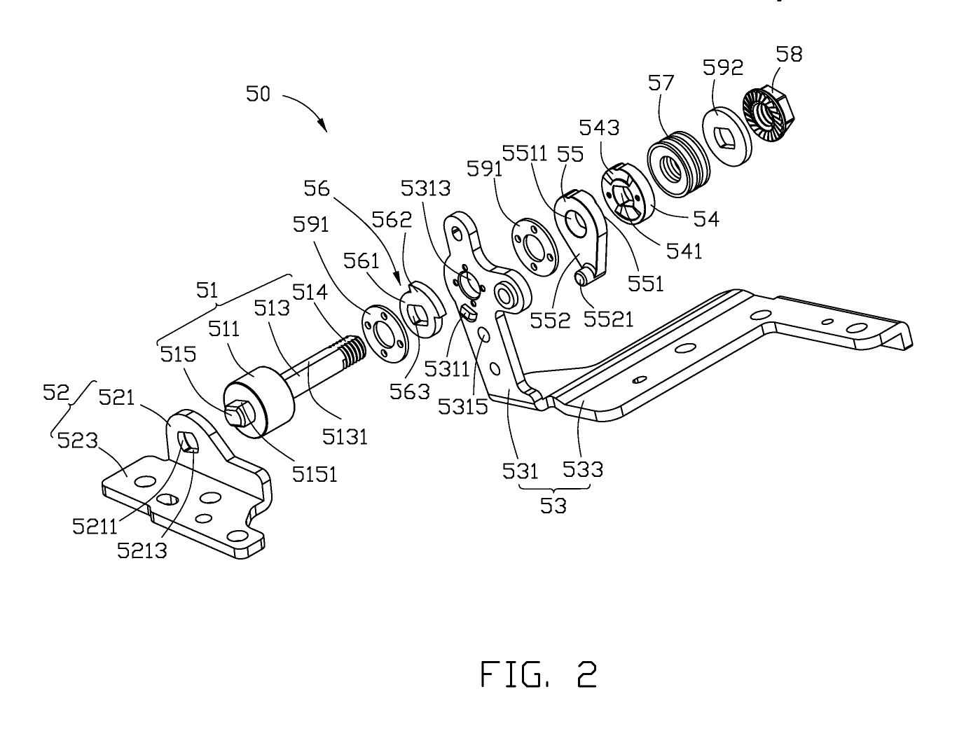

Referring to FIG. 2, an embodiment of the hinge assembly 50 includes a pivot shaft 51, a rotatable stand 52, a fixed stand 53, a cam follower 54, a cam 55, a restricting member 56, an elastic member 57, a fastening member 58, two friction members 591, and a flat washer 592.

The pivot shaft 51 includes a shaft portion 513. The shaft portion 513 has two first positioning surfaces 5131 on opposite sides of the shaft portion 513. A flange 511 is formed on a proximal end of the shaft portion 513, and a threaded portion 514 is formed on a distal end of the shaft portion 513. A shaft head 515 is formed on the flange 511 along an extending direction of the shaft portion 513. The shaft head 515 defines two second positioning surfaces 5151 on opposite sides of the shaft head 515. Each second positioning surface 5151 is coplanar with one corresponding first positioning surface 5131.

The rotatable stand 52 includes a first base plate 521 and a first fixing plate 523 extending substantially perpendicularly from a side of the first base plate 521. The first base plate 521 defines a connecting hole 5211 corresponding to the shaft head 515. Two connecting surfaces 5213, corresponding to the two second positioning surfaces 5151 of the shaft head 515, are formed on the sidewall in the connecting hole 5211. When the shaft head 515 is received in the connecting hole 5211 of the first base plate 521, the second positioning surfaces 5151 resist the connecting surfaces 5213, thus non-rotatably connecting the rotatable stand 52 to the pivot shaft 51. The first fixing plate 523 is fixedly connected to the cover 30. The connecting surfaces 5213 of the rotatable stand 52 are oblique to the first fixing plate 523.

The fixed stand 53 includes a second base plate 531 and a second fixing plate 533 extending substantially perpendicularly from a side of the second base plate 531. The second base plate 531 defines a circular pivot hole 5313 in an end away from the second fixing plate 533, and a fixing hole 5315 in a middle portion. A limiting protrusion 5311 is formed on the second base plate 531 adjacent to the pivot hole 5313. The second fixing plate 533 is fixedly connected to the main body 10.

The cam follower 54 is substantially cylindrical. A center of the cam follower 54 defines a non-circular through hole 541 corresponding to the shape of the shaft portion 513 of the pivot shaft 51. The cam follower 54 defines two positioning cutouts 543 in a side surface.

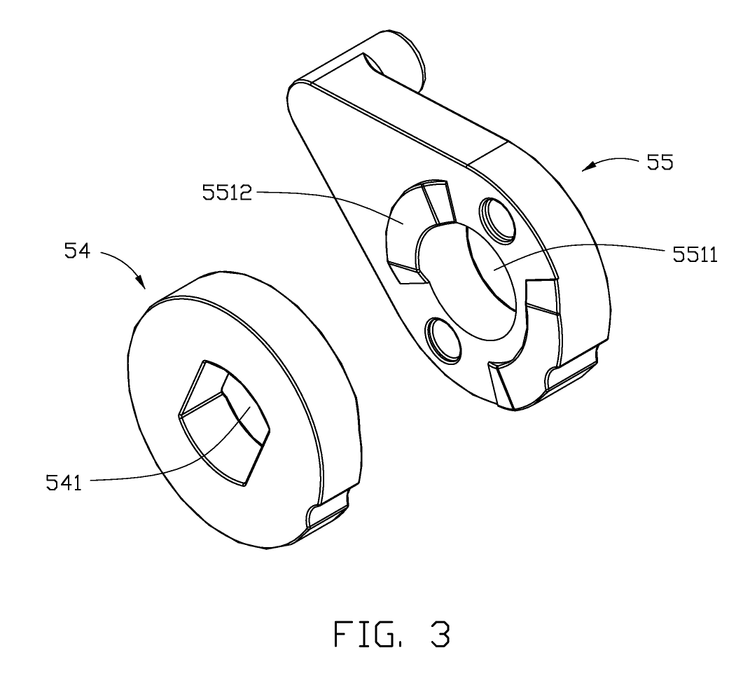

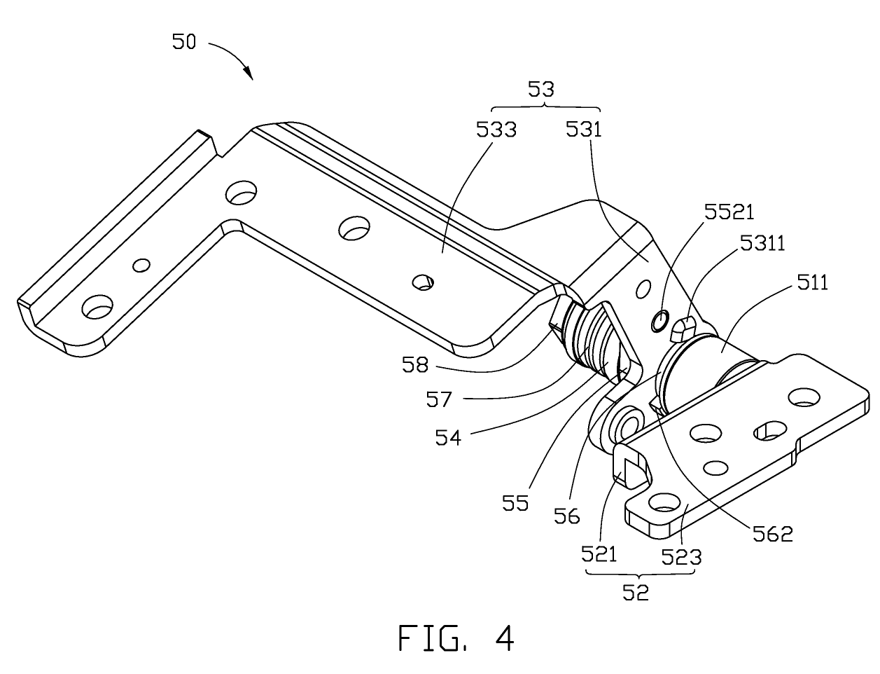

The cam 55 includes a cylindrical assembling portion 551 and a positioning portion 552 formed at one end of the assembling portion 551. In this embodiment, the positioning portion 552 is substantially triangular-shaped. A center of the assembling portion 551 defines a substantially circular cam hole 5511. Referring also to FIG. 3, two positioning protrusions 5512 are formed on a side surface of the assembling portion 551. Each positioning protrusion 5512 is configured for engaging with one corresponding positioning cutout 543 of the cam follower 54. A positioning pole 5521 extends from the positioning portion 552.

The restricting member 56 includes a circular main portion 561. A center of the main portion 561 defines a non-circular through hole 563 corresponding to the shape of the shaft portion 513 of the pivot shaft 51. A restricting portion 562 is formed at an edge of the main portion 561. In this embodiment, the first restricting portion 562 is an arched protrusion radially extending from an edge of the main portion 561.

In the illustrated embodiment, the elastic member 57 is composed of a plurality of spring washers 57, and the fastening member 58 is a nut configured to engage with the threaded portion 514 of the pivot shaft 51.

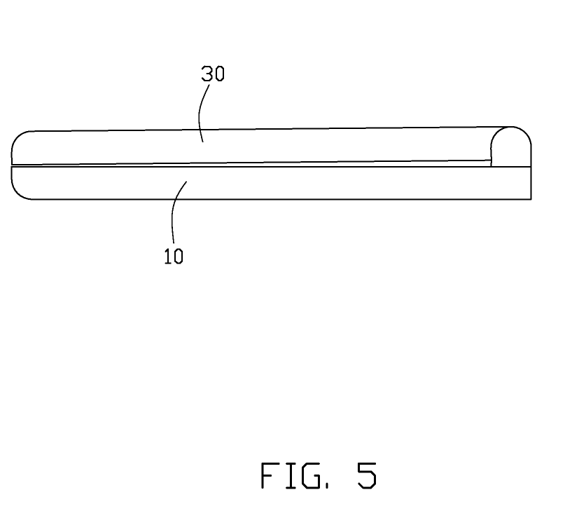

Referring to FIGS. 2 through 4, in assembling the hinge assembly 50, the threaded portion 514 of the pivot shaft 51 extends through one friction member 591, the through hole 563 of the restricting member 56, the pivot hole 5313 of the fixed stand 53, the other friction member 591, the cam hole 5511 of the cam 55, the through hole 541 of the cam follower 54, the elastic member 57, the flat washer 592, and engages with the fastening member 58. The shaft head 515 engages with the rotatable stand 52. Therefore, the rotatable stand 52, the restricting member 54, and the cam follower 54 are non-rotatably connected to the pivot shaft 31. The positioning pole 5521 of the cam 55 is inserted into the fixing hole 5315 of the fixed stand 53. The positioning protrusions 5512 of the cam 55 are capable of engaging in the positioning cutouts 543 of the cam follower 54. The fastening member 58 can be adjusted on the pivot shaft 51, such that the elastic member 57 becomes elastically deformed and applies an elastic force on the cam follower 54. After the hinge assembly 50 is assembled, the rotatable stand 52 is fixedly connected to the main body 10, and the fixed stand 53 is fixedly connected to the main body 10.

When the electronic device 100 needs to be closed, the cover 30 is rotated towards the main body 10, and the rotatable stand 52 is rotated on the pivot shaft 51, for example, in a clockwise direction. The pivot shaft 51 rotates together with the rotatable stand 52, and the restricting member 56 and the cam follower 54 rotate together with the pivot shaft 51. When the restricting portion 562 of the restricting member 56 resists the limiting protrusion 5311 of the fixed stand 53, the rotatable stand 52 has reached a clockwise rotatable limit and cannot rotate any further in the clockwise direction. At the clockwise rotatable limit, the positioning protrusions 5512 of the cam 55 engage in the corresponding positioning cutouts 543 of the cam follower 54 driven by the elastic force of the elastic member 57. Then, the cover 30 is closed to the main body 10 as shown in the FIG. 5.

Since the connecting surfaces 5213 of the rotatable stand 52 is oblique to the first fixing plate 523, and the second positioning surfaces 5151 is substantially parallel to the first positioning surfaces 5131, when the shaft head 515 is received in the connecting hole 5211, the first positioning surfaces 5131 of the shaft portion 513 is also oblique to first fixing plate 523. Therefore, the second fixing plate 533 of the fixed stand 53 is oblique to the first fixing plate 523 of the rotatable stand 52, because the fixed stand 53 is non-rotatably connected to the shaft portion 513. When the cover 30 is brought towards the main body 10, the cover 30 is oblique to the main body 10, with the cover 30 contacting the main body 10 at an end away from the hinge assembly 50 as shown in FIG. 5. Thus, the cover 30 does not wobble relative to the main body 10. That is, the cover 30 is firmly closed to the main body 10.

It should be pointed out that the cover 30 can also be oblique to the main body 10 in a closed state by changing a structure of the hinge assembly 50. For example, the first positioning surfaces 5131 of the shaft portion 513 can be oblique to the second positioning surfaces 5151 of the shaft head 515, and the connecting surfaces 5213 of the rotatable stand 52 are substantially parallel to the first fixing plate 523. When the pivot shaft 51 is engaged with the rotatable stand 52, the first positioning surfaces 5131 are oblique to the first fixing plate 523. Thus, when the positioning protrusions 5512 of the cam 55 engage in the corresponding positioning cutouts 543 of the cam follower 54, the second fixing plate 533 is oblique to the first fixing plate 523. That is, the cover 30 is oblique to the main body 10 in the closed state. In addition, the cover 30 can be oblique to the main body 10 in the closed state by changing the positions of the positioning protrusions 5512 on the cam 55. Moreover, one or more positioning protrusions can be formed on the cam follower 54, and the cam 55 can define one or more positioning cutouts corresponding to the one or more positioning protrusions. The cam 55 can also be non-rotatably connected to the pivot shaft 51, and the cam follower 54 is rotatably connected to the pivot shaft 51.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A hinge assembly, comprising:
a pivot shaft;
a rotatable stand non-rotatably connected to the pivot shaft and having a first fixing plate;
a fixed stand rotatably connected to the pivot shaft and having a second fixing plate;
a fastening member engaging with an end of the pivot shaft;
a cam; and
a cam follower, wherein one of the cam and the cam follower defines at least one positioning cutout, and at least one positioning protrusion is formed on the other one of the cam and the cam follower; one of the cam and the cam follower is rotatably connected to the pivot shaft; when the at least one positioning protrusion engages in the at least one positioning cutout, the first fixing plate is oblique to the second fixing plate.

2. The hinge assembly of claim 1, wherein the pivot shaft comprises a shaft portion; the shaft portion defines two first positioning surfaces on opposite sides; the cam follower is non-rotatably sleeved on the shaft portion, and contacts the first positioning surfaces.

3. The hinge assembly of claim 2, wherein a flange is formed on a proximal end of the shaft portion, and a threaded portion is formed on a distal end of the shaft portion; a shaft head is formed on the flange along an extending direction of the shaft portion; the shaft head defines two second positioning surfaces on opposite sides; the rotatable stand is non-rotatably sleeved on the shaft head, and contacts the second positioning surfaces.

4. The hinge assembly of claim 3, wherein each of the second positioning surfaces is aligned with one corresponding first positioning surface in a same plane.

5. The hinge assembly of claim 4, wherein the rotatable stand comprises a first base plate extending substantially perpendicularly from a side of the first fixing plate; the first base plate defines a connecting hole; two connecting surfaces are formed on sidewalls of the connecting hole.

6. The hinge assembly of claim 5, wherein the connecting surfaces are oblique to the first fixing plate.

7. The hinge assembly of claim 6, wherein a fixing pole is formed on the cam; the fixed stand defines an assembling hole; the fixing pole is fixedly received in the assembling hole of the fixed stand.

8. The hinge assembly of claim 1, further comprising a restricting member sleeved on the pivot shaft; a restricting portion is formed on the restricting member, and a limiting protrusion is formed on the fixed stand; the limiting protrusion and the restricting member cooperatively define a rotating angle range between the rotatable stand and the fixed stand.

9. The hinge assembly of claim 1, further comprising an elastic member to generate an elastic force along the pivot shaft.

10. The hinge assembly of claim 1, further comprising two friction members sleeved on the pivot shaft, and positioned at opposite sides of the fixed stand.

11. The hinge assembly of claim 1, wherein a threaded portion is formed at the end of the pivot shaft; the fastening member is a nut engaged with the threaded portion.

12. An electronic device, comprising:
a main body;
a cover; and
a hinge assembly rotatably connected the cover to the main body, comprising:
a pivot shaft;
a rotatable stand non-rotatably connected to the pivot shaft, and fixed to the cover;
a fixed stand rotatably connected to the pivot shaft, and fixed to the main body;
a cam; and
a cam follower, wherein one of the cam and the cam follower defines at least one positioning cutout, and at least one positioning protrusion is formed on the other one of the cam and the cam follower; one of the cam and the cam follower is rotatably connected to the pivot shaft; when the at least one positioning protrusion engages in the at least one positioning cutout, the cover is obliquely closed to the main body, with the cover contacting the main body at an end away from the hinge assembly.

13. The electronic device of claim 12, wherein the pivot shaft comprises a shaft portion; the shaft portion defines two first positioning surfaces on opposite sides; the cam follower is non-rotatably sleeved on the shaft portion, and contacts the first positioning surfaces.

14. The electronic device of claim 13, wherein a flange is formed on a proximal end of the shaft portion, and a threaded portion is formed on a distal end of the shaft portion; a shaft head is formed on the flange along an extending direction of the shaft portion; the shaft head defines two second positioning surfaces on opposite sides, the rotatable stand is non-rotatably sleeved on the shaft head, and contacts the second positioning surfaces.

15. The electronic device of claim 14, wherein each of the second positioning surfaces is aligned with one corresponding first positioning surface in a same plane.

16. The electronic device of claim 15, wherein the rotatable stand comprises a first base plate and a first fixing plate extending substantially perpendicularly from a side of the first base plate; the first base plate defines a connecting hole; two connecting surfaces are formed on sidewalls of the connecting hole.

17. The electronic device of claim 16, wherein the connecting surfaces are oblique to the first fixing plate.

18. The electronic device of claim 17, wherein a fixing pole is formed on the cam; the fixed stand defines an assembling hole; the fixing pole is fixedly received in the assembling hole of the fixed stand.

19. The electronic device of claim 1, wherein the hinge assembly further comprises an elastic member to generate an elastic force along the pivot shaft.

20. The electronic device of claim 1, wherein the hinge assembly further comprises a restricting member sleeved on the pivot shaft; a restricting portion is formed on the restricting member, and a limiting protrusion is formed on the fixed stand; the limiting protrusion and the restricting member cooperatively define a rotating angle range between the rotatable stand and the fixed stand.
